(19) United States
(12) Patent Application Publication
(10) Pub. No.: US 2015/0035949 A1
(43) Pub. Date: Feb. 5, 2015

(54) METHOD FOR SYNCHRONISING SEVERAL CAMERAS WITH EACH OTHER IN A PHOTOGRAPHIC SYSTEM, IN PARTICULAR A STEREOSCOPIC PHOTOGRAPHIC SYSTEM, AND PHOTOGRAPHIC SYSTEM FOR IMPLEMENTING SAID METHOD

(71) Applicant: MORPHO, Issy Les Moulineaux (FR)

(72) Inventors: Alain ROUH, Issy Les Moulineaux (FR); Benoit MALRAT, Issy Les Moulineaux (FR)

(73) Assignee: MORPHO, Issy Les Moulineaux (FR)

(21) Appl. No.: 14/446,998

(22) Filed: Jul. 30, 2014

(30) Foreign Application Priority Data
Jul. 31, 2013 (FR) 13 57593

(51) Int. Cl. H04N 13/02; H04N 5/235

(52) U.S. Cl. CPC H04N 13/0296; H04N 13/0239; H04N 5/2354; H04N 5/2357
USPC 348/47

(57) ABSTRACT

The present invention concerns a method for synchronising several cameras with each other in a photographic system designed to take a multiple view of a scene, said cameras being of the CCD or CMOS digital type.

According to the invention, said method comprises the steps of:
illuminating said scene by means of a lighting system the lighting intensity of which varies periodically, and
setting each of said cameras in a so-called anti-flicker mode where they are themselves synchronised by phase locking on the variations in light intensity of the lighting system.

The invention also concerns a photographic system for implementing said method.

The present invention concerns a method for synchronising several cameras with each other in a photographic system, in particular a stereoscopic photographic system. The invention also concerns such a photographic system that implements said synchronisation method.

In photographic systems with several cameras, one problem often addressed is the one of synchronisation thereof on a same time basis. The case of stereoscopic systems that are used for 3D picture-taking of moving objects can be cited. To be usable, in order to determine a 3D model of the object that is placed in front of the cameras, each image taken by a camera in the stereoscopic system is matched with an image taken by the other camera in the system, normally at the same moment. In the case of static objects shot by both cameras, an offset in time between these two images does not in general pose a problem. These images correspond one to the other in so far as the object has the same spatial coordinates in both images. The same does not apply to objects that are moving. This is because, in this case, the image of the first camera is shot while the object is situated at one point and the image of the second camera is shot, without specific synchronisation means, when the object is situated at another point different from the first point owing to the movement of the object. If these points are very different, the images no longer correspond and cannot generally be used in 3D vision with sufficient precision. This is specially the case when the concerned object is moving at high speed in front of both cameras.

Thus, without any use of a special synchronisation method, the precision for matching images issued from several cameras may be insufficient for use in 3D vision.

To solve this problem, using synchronisation devices which transmit electrical pulses forming time references to each of the cameras in the photographic system is known. One such known synchronisation device is, for example, the device known as “Genlock”. This device is really efficient but the cameras must be equipped with means for receiving the time synchronisation pulses and for synchronising thereon. This is generally the case with cameras that are sophisticated and consequently expensive.

The purpose of the present invention is to propose a method for synchronising several cameras with each other in a photographic system that is efficient in terms of precision of matching of images respectively issued from these cameras and which is not aimed at sophisticated and expensive cameras.

To this end, a method for synchronising several cameras with each other in a photographic system intended to take a multiple shot of a scene, said cameras being of the CCD or CMOS digital type, is characterised in that it comprises the steps of:
illuminating said scene by means of a lighting system the lighting intensity of which varies periodically, and
setting each of said cameras in a so-called anti-flicker mode, where they are themselves synchronised by phase locking on the variations in light intensity of the lighting system.

According to an advantageous embodiment of the invention, said lighting system comprises a lighting system controlled by a specific power supply device, said cameras being synchronised on the variations in light intensity of the lighting system controlled by said specific power supply device.

The present invention also concerns a photographic system intended to take a multiple view of a scene and consisting of a plurality of cameras of the CCD or CMOS digital type. It is characterised in that it comprises:
a lighting system the lighting intensity of which varies periodically, said cameras being designed to function in a so-called anti-flicker mode where they are themselves synchronised by phase locking on the variations in illumination light intensity of the lighting system.

The features of the invention mentioned above, as well as others, will emerge more clearly from a reading of the following description of an example embodiment, said description being given in relation to the accompanying drawings, among which:

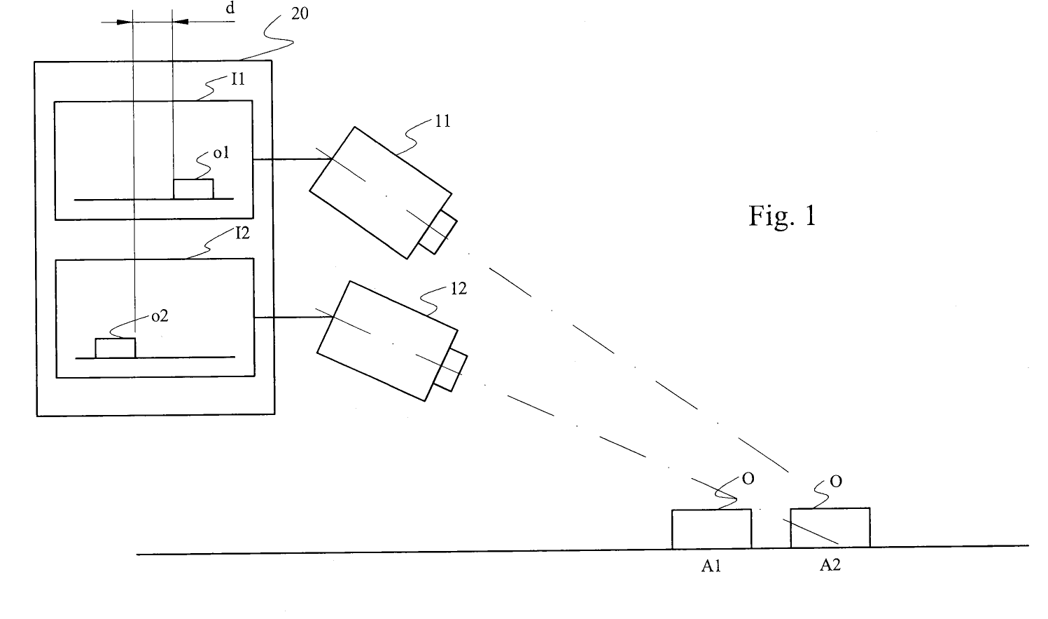

FIG. 1 is a view of a stereoscopic photographic system illustrating the problem that the present invention seeks to solve,

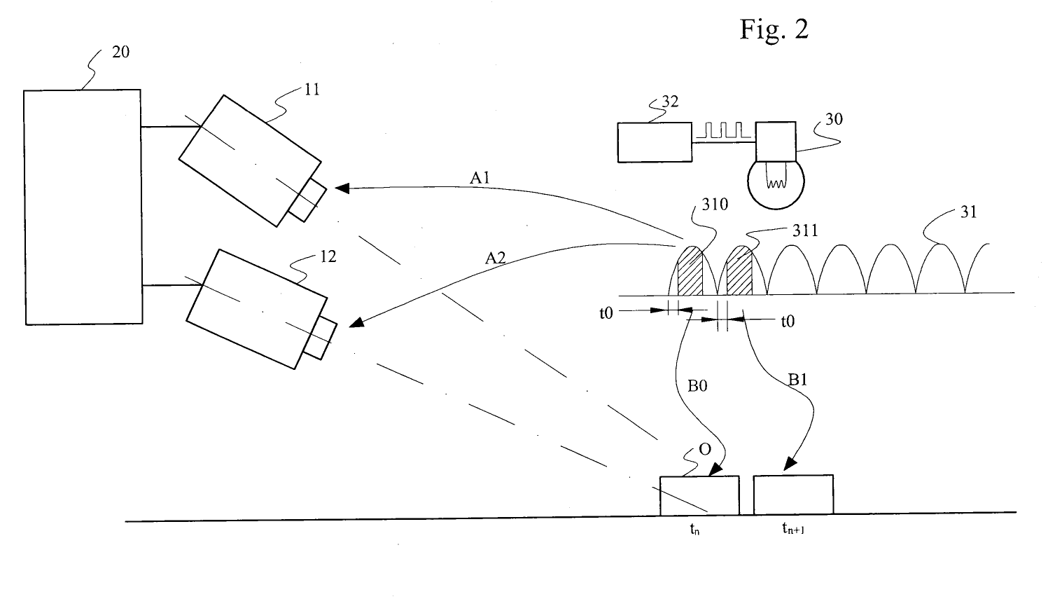

FIG. 2 is a view of a photographic system according to the present invention.

The photographic system depicted in FIG. 1 comprises two cameras 11 and 12 connected to an image processing device 20. The invention applies to photographic systems that comprise two cameras or more.

The cameras 11 and 12 are digital cameras, for example of the CCD (Charge Coupled Device) or CMOS (Complementary Metal Oxide Semiconductor) type. Cameras of one or other type comprise a sensor comprising photosites distributed as a mosaic. Each photosite functions in a first phase during which it integrates the light that it receives during a period of time, referred to as the integration period, thus accumulating an electrical charge, and in a second phase during which the electrical charge that it has integrated is transferred suitably to output circuits of the camera.

The processing device 20 is designed to process the two image signals respectively delivered by the cameras 11 and 12. These processing operations are for example a matching of the images issuing from these signals in order to derive therefrom the geometric and topological characteristics of an object O of a scene that is placed in front of the cameras 11 and 12. Thus a 3D model of the object O can be computed by the processing device 20.

FIG. 1 depicts, inside the box representing the processing device 20, two images I1 and I2 respectively issued from the image signals delivered by the cameras 11 and I2. It can be seen that the object O is represented by an element o1 in the image I1 of the camera 11 and by the element o2 in image I2 of the camera 12. It can be noted that these two elements o1 and o2 are offset from one image to the other by a distance d. This distance d is due to two phenomena: the difference in view of the cameras I1 and I2 that are spatially offset with respect to each other, and the time difference between the instants of shooting of the cameras I1 and I2, if there is any difference, combined with the movement of the object O that has travelled, between these two instants, from point A1 to point A2.

The processing that is carried out by the processing device 20 is generally based on the first of these two phenomena, the other phenomenon disturbing it in its processing. The synchronisation of the cameras 11 and 12 with each other enables overcoming the second phenomenon. This is because, if the time difference is zero (or at least is very small), the object O has practically not moved, or has not moved at all, between the two shots respectively taken by the cameras 11 and 12.

FIG. 2 depicts a same photographic system as the one of FIG. 1 with its two cameras 11 and 12 and its processing device 20. A lighting system 30 depicted in the form of a schematic lamp is also shown, as well as a diagram of its light intensity as a function of time 31, in the form of a rectified sinusoid (the negative half-cycles being rectified positively). This variation in light intensity with time may be that of a fluorescent lamp or fluorescent tube, for example a very low pressure mercury vapour lamp, supplied from the mains. It may also be a sodium light source, such as public lighting, or a neon source. It may be a case of a lighting system with light emitting diodes (LEDs) controlled by a suitable “pulsed” supply device. If the mains frequency is 50 Hz, the period between two peaks of the rectified sinusoid is 10 ms. If it is 60 Hz, this period is 8.3 ms.

According to the present invention, the synchronisation of the cameras 11 and 12 with each other is achieved by making both function in a so-called anti-flicker mode wherein they are themselves synchronised with the variations in illumination light intensity of the lighting system 30 that is used for this synchronisation.

In general terms, a digital camera may be subject to flickers in the resulting video, in particular when the period between integrations of its sensor is not in keeping with the frequency of the light intensity of the captured scene. For example, the patent U.S. Pat. No. 6,271,884 addresses the problem of this flicker and proposes a solution that consists of providing an integration time for the sensor forming part of the concerned camera that is a multiple of the period of the variation in light intensity. If such is the case, there is no longer any flicker.

Thus, if the frequency of the light intensity is 50 Hz, the integration time, according to this patent, will have to be a multiple of 10 ms. If it is 60 Hz, the integration time should be a multiple of 8.33 ms.

Another solution to this flicker problem consists, by phase locking, in synchronising the integration period with the period of the variation in light intensity of the light signal. This phase locking synchronisation mode solves the problem mentioned in the preamble to the present description of the synchronisation of the cameras 11 and 12 with each other. In addition, it enables shorter integration times than the first solution, which may be advantageous under conditions of high luminosity, shooting objects moving rapidly, or high image rates.

In FIG. 2, the integration periods of the cameras 11 and 12 are referenced 310 and 311. The arrows A1 and A2 illustrate that the cameras 11 and 12 are taking a shot of the scene during the period of time 310. The arrows B0 and B1 illustrate that each camera 11, 12 is taking, during the integration periods 310 and 311, shots respectively for the times tn and tn+1. The integration periods 310 and 311 both start at a time t0 after the zero crossing of the light intensity. They are of a duration less than the period of the light intensity. Thus the phase of triggering of the shots carried out by the cameras 11 and 12 is locked on the light intensity at a phase value corresponding to the time t0. The integration periods 310 and 311 are then in synchronism and phase locked with the periodicity of the variation in the lighting intensity of the lighting system 30.

The lighting system 30 that is used by the present invention is generally a lighting system that is present in the area where the cameras 11 and 12 are situated, for example to illuminate this area. This lighting system 30 is therefore in general not specific to the synchronisation of the cameras 11 and 12 with each other but it is nevertheless used for this purpose for the periodicity of its emitted light intensity, because in particular of its supply on the mains.

This lighting system (like the lighting system 30 of FIG. 2) could advantageously be a lighting system (for example with light emitting diodes, controlled by a pulsed specific supply device 32 delivering an alternating current at one or other of these frequencies 50 Hz or 60 Hz.

It may be a complex lighting system integrating a first lighting system 30 of the area in which the cameras 11 and 12 are situated, supplied by the mains of the place of said area, and a second lighting system controlled by a specific supply device, such as the device 32. Advantageously, in the latter case, if the first lighting system supplied by the mains 30 of the area has a frequency of variation in light intensity of 50 Hz, the second lighting system controlled by the device 32 has a frequency of variation in light intensity of 60 Hz and vice versa. The advantage of such a solution is to perform synchronisation of the cameras 11 and 12 on a light scene the properties of which are known and controlled, making the system more reliable. It also enables to establish the synchronisation of the cameras 11 and 12 on a frequency that is different from the mains supply frequency of the country in which the photographic system is situated and consequently from the frequency of the ambient lighting sources of this country.

1. Method for synchronising several cameras in a photographic system intended to take a multiple view of a scene, said cameras being of the CCD or CMOS digital type, characterised in that it comprises the steps of:
use of a lighting system the lighting intensity of which varies periodically,
illumination of said scene by means of said lighting system, and
adjustment of each of said cameras in a so-called anti-flicker mode in which they are themselves synchronised by phase locking on the variations in light intensity of the lighting system.

2. Synchronisation method according to claim 1, characterised in that said use step consists of using a lighting system that is supplied by the mains and the light intensity of which varies therewith, said cameras being synchronised by phase locking on the variations in light intensity of said lighting system.

3. Synchronisation method according to claim 1, characterised in that said use step consists of using a lighting system that is controlled by a pulsed specific supply device and the light intensity of which varies at the frequency of the oscillating current delivered by said device, said cameras being synchronised by phase locking on the variations in light intensity of said lighting system controlled by said specific supply device.

4. Photographic system intended to take a multiple view of a scene consisting of a plurality of cameras of the CCD or CMOS digital type, characterised in that it comprises:
a lighting system the lighting intensity of which varies periodically, said cameras being designed to function in a so-called anti-flicker mode where they are themselves synchronised by phase locking on the variations in light intensity of the lighting system.

5. Photographic system according to claim 4, characterised in that said lighting system comprises a lighting system controlled by a specific power supply device, said cameras being synchronised on the variations in light intensity of said lighting system controlled by said specific supply device.

6. Photographic system according to claim 5, characterised in that said controlled lighting system is controlled by a power supply device at a frequency different from that of the mains.

7. Synchronisation method according to claim 2, characterised in that said use step consists of using a lighting system that is controlled by a pulsed specific supply device and the light intensity of which varies at the frequency of the oscillating current delivered by said device, said cameras being synchronised by phase locking on the variations in light intensity of said lighting system controlled by said specific supply device.
